(19) United States
(12) Patent Application Publication
(10) Pub. No.: US 2002/0138600 A1
(43) Pub. Date: Sep. 26, 2002

(54) Method, apparatus and program for multi-machine network install using writeable media

(75) Inventor: Sandeep K. Singhal, Englewood Cliffs, NJ (US)

Correspondence Address: A. Bruce Clay, IBM Corporation T81/503, P.O. Box 12195, Research Triangle Park, NC, 27709, US

(73) Assignee: International Business Machines Corporation, Armonk, NY (US)

(21) Appl. No.: 09/817,637

(22) Filed: Mar. 26, 2001

(51) Int. Cl. G06F 15/173

(52) U.S. Cl. 709/223

(57) ABSTRACT

The present invention provides a mechanism for performing a network installation where the machines do not need to be networked in advance and where user errors are minimized. The present invention provides writable media, such as a floppy disk, along with a software install. As software is installed on each machine, configuration information is stored on the writable media. At each machine, the installation software is now able to search the writable media to dynamically learn about the installation options made at other machines. When the location of another software application is required, the installation software may produce a list of possible hosts based on configuration information on the writable media. When a preference is required to configure an application, the installation software may select appropriate default values based on values used in previous installations of the same software or related applications. A user may be prompted to clone the configuration of a previous installation of the same application.

### FIELD OF THE INVENTION

The present invention relates to data processing systems and, in particular, to network installation. Still more particularly, the present invention provides a method, apparatus, and program for multiple machine network installation using writable media.

### BACKGROUND OF THE INVENTION

Complex multiple machine systems require the installation of software components on multiple machines. Tr hese systems can be configured in a variety of ways, depending on the size of the desired installation and the particular services being installed. Traditionally, two approaches exist for these systems: network install and single machine install.

With a network install, the system is configured at a single operator console. Once the system has been properly configured, the software components are transmitted over the network to the various target machines. However, this approach requires that all machines are networked together and that bootstrapping code be pre-installed on each target to machine; this bootstrapping code is required for receiving the transmitted software components and for managing the local installation process.

With single machine install, the user types configuration information and installs the appropriate software components on each machine. This approach is prone to human error, particularly as the number of machines and software components increases.

Therefore, it would be advantageous to provide a method, apparatus, and program for providing improved multiple machine installation that does not require the machines to be networked and is not prone to human error.

### SUMMARY OF THE INVENTION

The present invention provides a mechanism for performing a network installation where the machines do not need to be networked in advance and where user errors are minimized. The present invention provides writable media, such as a floppy disk, along with a software install. As software is installed on each machine, configuration information is stored on the writable media. At each machine, the installation software is now able to search the writable to media to dynamically learn about the installation options made at other machines.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented;

FIG. 2 is a block diagram of a data processing system in which the present invention may be implemented;

FIG. 3 is a block diagram illustrating the data flow between software and hardware devices in accordance with a preferred embodiment of the present invention; and

FIG. 4 is a flowchart illustrating a configuration process performed by installation software in accordance with a preferred embodiment of the present invention.

### DETAILED DESCRIPTION OF THE PREFERRED EMBODIMENT

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y.

Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

In accordance with a preferred embodiment of the present invention, multiple computers, such as computer 100, may be configured with software without being networked. Removable storage 120 may be used to store configuration information as software is installed. For example, installation of a firewall on computer 100 may output the following information to removable storage 120:

[Machine: 10.21.9.124]

Firewall-installed: Yes

Firewall-vendor: IBM

Firewall-version: 3.1

Firewall-destination-host: 10.11.3.91

Firewall-source-host: 10.10.3.52

Firewall-configuration: LDAP@10.3.91.80 At another machine, the installation software may now search the removable storage media to dynamically learn about the installation options made at computer 100.

Thus, configuration information on the writeable storage 120 may be used to assist in subsequent installations. For example, when the location of a particular piece of software is required, the installation software may produce a pop-up window of possible hosts (upon which the required software has already been installed) based on information in the file. When a particular preference is required, the installation software may select an appropriate default value based on values used in previous installations of the same software or particular features. At the beginning of installation, the user may be prompted with the option to “clone” the configuration of another pre-existing software installation.

Removable storage 120 is shown as a floppy disk. However, other forms of removable writeable media may be used, such as compressed media, re-writeable compact disks, or flash memory. The installation software and applications that are to be installed may be embodied on removable storage 120 or other removable storage, such as a compact disk or compressed media.

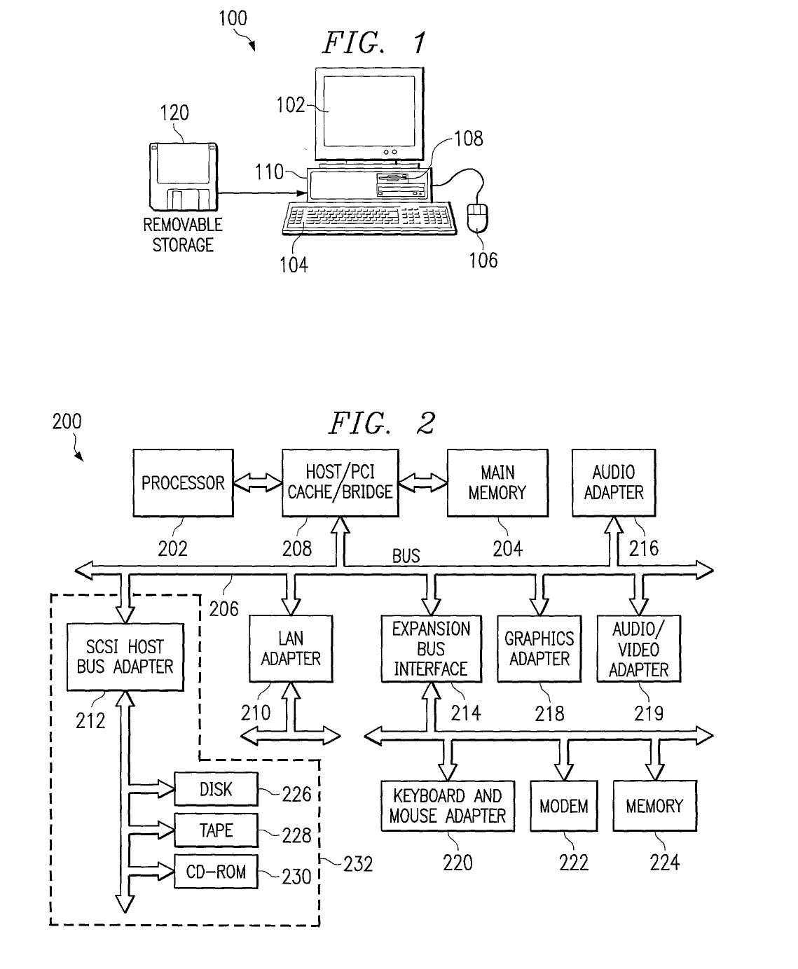

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, floppy adapter 219, and expansion bus interface 214 may be connected to PCI local bus 206 by direct component connection. In contrast, audio adapter 216 and graphics adapter 218 may be connected to PCI local bus 206 by add-in boards inserted into expansion slots. Expansion bus interface 214 provides a connection for keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk, a Web appliance, or a telephone device.

The processes of the present invention are performed by processor 202 using computer implemented instructions, which may be located in a memory such as, for example, main memory 204, memory 224, or in one or more peripheral devices 226-230.

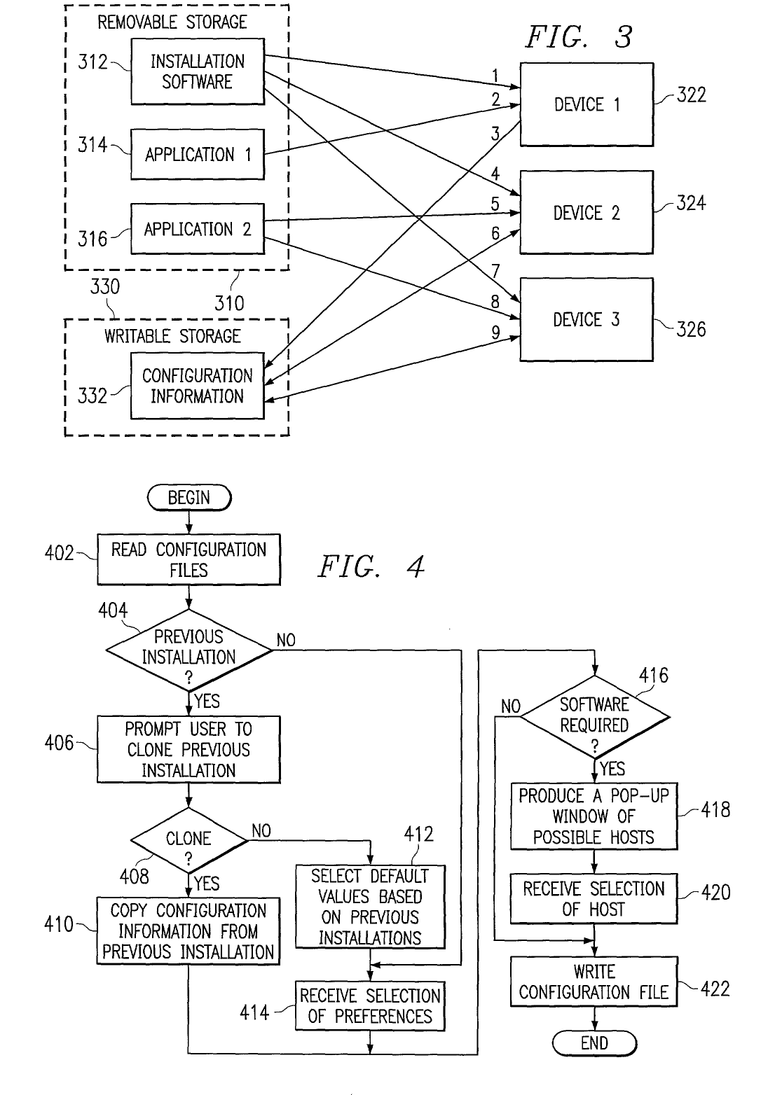

With reference now to FIG. 3, a block diagram illustrating the data flow between software and hardware devices is shown in accordance with a preferred embodiment of the present invention. Removable storage 310 includes installation software 312, application 1 314, and application 2 316. Installation software 312 runs on devices 1 322, device 2 324, and device 3 326 to manage software installation and configuration. Application 1 314 and application 2 316 may be installed on any of device 1, device 2, and device 3. Writeable storage 330 stores configuration information 332 from installation of software on device 1, device 2, and device 3.

Though FIG. 3 depicts a single installation software 312 for managing the applications 314 and 316, alternative embodiments of the present invention may employ different installation software for one or more or each installable application without detracting from the inventive concepts herein.

Particularly, with respect to FIG. 3, an example is shown in which applications are installed and configured on the devices. The data flows between the removable storage, the devices, and the writeable storage as described in the following steps:

1. The installation software is loaded onto device 1 and executed.

2. An operator uses the installation software to install and configure application 1 on device 1.

3. The configuration information for device 1 is stored on the writeable storage.

4. The installation software is loaded onto device 2 and executed.

5. The operator initiates installation and configuration of application 2 on device 2.

6. During the configuration of application 2, the configuration information for device 1 is read from the writeable storage. The configuration information for device 1 may be used to configure application 2 on device 2. For example, if application 1 is a database server and application 2 is a search engine or other software that will use the database server as a resource, then the installation software searches the configuration information for the address of the database server. Once application 2 is installed and configured on device 2, the configuration information for device 2 is stored on the writeable storage.

7. The installation software is loaded onto device 3 and executed.

8. The operator initiates installation and configuration of application 2 on device 3.

9. During the configuration of application 2, the configuration information for device 1 and device 2 is read from the writeable storage. The configuration information for device 1 may be used to configure application 2 on device 3. Also, the configuration information for device 2 may be used to select appropriate default values based on the previous installation of application 2. Furthermore, at the beginning of installation of application 2 on device 3, the operator may be prompted to whether to clone the previous configuration of application 2. For example, a search engine may be installed on device 3. The installation software may detect that a previous installation of the search engine was performed on device 2 and prompt the operator whether to clone the previous installation. The configuration information for device 3 is then stored on the writeable storage.

For purposes of illustration, the installation software, application 1, and application 2 are embodied on removable storage 310, which may be a compact disk, compressed media, floppy disk, or other removable media. However, the installation software, application 1, and application 2 may be embodied on removable media separately. For example, each one of application 1 and application 2 may be embodied on a separate compact disk. Any combination of installation software, application 1, and application 2 may be embodied on writeable storage 330, which may be a floppy disk, such as removable storage 120 in FIG. 1, compressed media, a hard drive, or other media. Moreover any combination of installation software, application 1, and application 2 may be embodied in memory media such as DRAM, SRAM, or ROM.

Writeable storage 330 may also be embodied on a central storage, which may be accessed by each device individually and independently, such as by a dial-up connection. The writeable storage may also be accessed using a Bluetooth device. Bluetooth is an open standard for short-range transmission of digital voice and data between mobile devices and desktop devices. It supports point-to-point and multipoint applications. Using a central storage that may be accessed by devices independently allows a plurality of technicians to configure devices without the need to share a single removable storage device.

Device 1, device 2, and device 3 may be a computer, such as computer 100 in FIG. 1, or other computing device that may be networked, such as a notebook computer, a personal digital assistant (PDA), a network computer, a gaming device, a telephone device, or a web appliance.

With reference now to FIG. 4, a flowchart is shown illustrating a configuration process performed by installation software in accordance with a preferred embodiment of the present invention. The process begins and reads configuration files (step 402). A determination is made as to whether a previous installation exists for the application being installed (step 404). If a previous installation for the application exists, the process prompts the user whether to clone the previous installation (step 406) and a determination is made as to whether the user instructs the software to clone the installation (step 408).

If the user instructs the software to clone the previous installation, the process applies the configuration information from the previous installation (step 410) and proceeds to step 416 to determine whether information about other installed software is required to complete the installation. If the user instructs the software not to clone the previous installation in step 408, the process selects default values for the configuration of the application based on previous installations (step 412), receives the user's selection of configuration preferences (step 414), and proceeds to step 416 to determine whether information about other installed software is required to complete the installation.

Returning to step 404, if no previous installations for the application exist, the process receives the user's selection of configuration preferences (step 414) and a determination is made as to whether information about other installed software is required to complete the installation (step 416).

If information about another application is required in step 416, the process produces a pop-up window of possible hosts (step 418) according to information obtained to the read configuration files and receives a selection of a host (step 420). If no host addresses are available, an address may be entered manually by the user in step 420. Also, a default may be automatically highlighted or selected in step 420 based on configuration information cloned from a previous installation. Thereafter, the process writes to a configuration file (step 422) describing the chosen application configuration and ends. If information about another application is not required in step 416, the process writes to a configuration file (step 422) describing the chosen application configuration and ends.

A configuration file may be written for each installation of an application on a device. Alternatively, a configuration file may have stored therein configuration information for all applications installed on a device. A configuration file may also have stored therein configuration information for an entire network install delimited by device identity and/or application identity.

Thus, the present invention solves the disadvantages of the prior art by storing configuration information on removable, writeable media. Installation software may read the configuration information of previous installations to assist in configuration. When the location of another software application is required, the installation software may produce a list of possible hosts based on configuration information on the writeable media. When a preference is required to configure an application, the installation software may select appropriate default values based on values used in previous installations of the same software or related applications. A user may be prompted whether to clone the configuration of a previous installation of the same application. Thus, the present invention provides a mechanism for performing a multiple machine network installation without requiring the machines to be networked at the time of installation.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer to readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for configuring a network, comprising:
configuring a first device for use in the network;
storing first configuration information for the first device on a storage device;
reading the first configuration information from the storage device at a second device; and
configuring the second device for use in the network based on the first configuration information,
wherein the step of configuring the first device and the step of configuring the second device are performed prior to networking the first device and the second device.

2. The method of claim 1, wherein the step of configuring the first device comprises configuring a host application.

3. The method of claim 2, wherein the first configuration information includes a host address.

4. The method of claim 2, wherein the step of configuring the second device comprises configuring a client application to communicate with the host application over the network.

5. The method of claim 3, wherein the host application is selected from a list of possible host applications for the client application.

6. The method of claim 1, further comprising:
storing second configuration information for the second device on the storage device.

7. The method of claim 1, wherein the step of configuring the second device comprises generating default values based on the first configuration information.

8. The method of claim 1, wherein the step of configuring the second device comprises copying the configuration of the first device.

9. The method of claim 1, wherein the storage device is a floppy disk.

10. A method for configuring a network, comprising:
reading first configuration information, for a first device configured for use in the network, from a storage device at a second device; and
configuring the second device for use in the network based on the first configuration information,
wherein the step of configuring the second device is performed prior to networking the second device.

11. The method of claim 10, wherein the first configuration information includes a host address.

12. The method of claim 11, wherein the step of configuring the second device comprises configuring a client application to communicate with a host application at the host address over the network.

13. The method of claim 2, wherein the host address is selected from a list of possible host addresses for the client application.

14. The method of claim 10, further comprising:
storing second configuration information for the second device on the storage device.

15. The method of claim 10, wherein the step of configuring the second device comprises generating default values based on the first configuration information.

16. The method of claim 10, wherein the step of configuring the second device comprises copying the configuration of the first device.

17. The method of claim 10, wherein the storage device is a floppy disk.

18. An apparatus for configuring a network, comprising:
first configuration means for configuring a first device for use in the network;
storage means for storing first configuration information for the first device;
reading means for reading the first configuration information from the storage device at a second device; and
second configuration means for configuring the second device for use in the network based on the first configuration information,
wherein the first device and the second device are configured prior to networking the first device and the second device.

19. The apparatus of claim 18, wherein the first configuration means comprises means for configuring a host application.

20. The apparatus of claim 19, wherein the first configuration information includes a host address.

21. The apparatus of claim 19, wherein the second configuration means comprises means for configuring a client application to communicate with the host application over the network.

22. The apparatus of claim 19, wherein the host application is selected from a list of possible host applications for the client application.

23. The apparatus of claim 18, wherein the second configuration means comprises means for generating default values based on the first configuration information.

24. The apparatus of claim 18, wherein the second configuration means comprises means for copying the configuration of the first device.

25. The apparatus of claim 18, wherein the storage means comprises a floppy disk.

26. An apparatus for configuring a network, comprising:
reading means for reading configuration information, for a first device configured for use in the network, from a storage device at a second device; and
configuration means for configuring the second device for use in the network based on the first configuration information,
wherein the second device is configured prior to networking the second device.

27. The apparatus of claim 26, wherein the configuration information includes a host address.

28. The apparatus of claim 27, wherein the configuration means comprises means for configuring a client application to communicate with a host application at the host address over the network.

29. The apparatus of claim 28, wherein the host address is selected from a list of possible host addresses for the client application.

30. The apparatus of claim 26, wherein the configuration means comprises means for generating default values based on the configuration information.

31. The apparatus of claim 26, wherein the configuration means comprises means for copying the configuration of the first device.

32. The apparatus of claim 26, wherein the storage device is a floppy disk.

33. A computer program product, in a computer readable medium, for configuring a network, comprising:
instructions for configuring a first device for use in the network;
instructions for storing first configuration information for the first device on a storage device;
instructions for reading the first configuration information from the storage device at a second device; and
instructions for configuring the second device for use in the network based on the first configuration information,
wherein the first device and the second device are configured prior to networking the first device and the second device.

34. A computer program product, in a computer readable medium, for configuring a network, comprising:
instructions for reading first configuration information, for a first device configured for use in the network, from a storage device at a second device; and
instructions for configuring the second device for use in the network based on the first configuration information, wherein the second device is configured prior to networking the second device.
